(19) United States
(12) Patent Application Publication
(10) Pub. No.: US 2026/0221372 A1
(43) Pub. Date: Jul. 30, 2026

(54) SYSTEM AND METHOD FOR ADJUSTING FLUOROSCOPY IMAGING CONDITIONS

(71) Applicant: CANON MEDICAL SYSTEMS CORPORATION, Otawara-shi (JP)

(72) Inventors: Marco RAZETO, Edinburgh (GB); Yvonne BELTON, Edinburgh (GB); Corne HOOGENDOORN, Edinburgh (GB); James MATTHEWS, Edinburgh (GB)

(73) Assignee: Canon Kabushiki Kaisha, Tokyo (JP)

(21) Appl. No.: 19/037,461

(22) Filed: Jan. 27, 2025

(51) Int. Cl. H01J 35/14; G01T 1/17; G01T 1/29; G01T 1/36; G01T 7/00

(52) U.S. Cl. CPC H01J 35/14; G01T 1/17; G01T 1/2992; G01T 1/361; G01T 7/005

(57) ABSTRACT

A system receives captured images of the object and supplies these to an image recognition model to identify whether or not an unintended part of an operator (e.g. a hand) is present within the path of an X-ray beam. If the unintended part is present, a control signal is supplied to the imaging apparatus to cause appropriate action to be carried out to reduce or eliminate irradiation to the unintended part. The system subsequently determines whether a predefined condition is met. The predefined condition may, for example, be a failure by the image recognition model to detect the unintended part in subsequent captured images. The imaging apparatus may then be restored to normal operation mode. In this way, the system with a high reliability responds to the presence of an unintended part in the X-ray beam by reducing the irradiation when required, but increasing image quality and size of the imaged region to a preferred level when the unintended part is removed.

### TECHNICAL FIELD

The present disclosure relates to a data processing system and a method for performing fluoroscopy imaging and, in particular for adjusting fluoroscopy imaging conditions.

### BACKGROUND

Fluoroscopy imaging is an X-ray imaging technique performed to obtain a series of real-time images of an object (e.g. a part of a patient and/or medical instrument). The real-time images are captured closely together in time, such that they provide frames of a video. Fluoroscopy images are obtained using an X-ray tube to generate X-rays and an X-ray detector for capturing the X-rays transmitted through an imaging object. The X-ray tube and detector are positioned on either side of the object and may be rotated about the object so as to obtain images of the object from different angles. Fluoroscopy is often used to provide imaging of the internal structure of a patient and can be used to provide imaging for guiding the insertion of a medical instrument, such as a catheter.

During a fluoroscopy procedure, an operator of the imaging apparatus, or other medical staff members that are present during the procedure, may be exposed to X-ray radiation. For example, X-rays may scattered from the object being imaged, or other objects present in the path of the X-ray beam, and reach the operator of the imaging apparatus. In addition, direct exposure to the X-rays may also occur if the operator or another medical staff member places a part of their body (e.g. one or both of their hands) within the X-ray beam. Such direct exposure is particularly likely in the event that the operator or another medical staff member is handling an instrument that is part of the captured images, e.g. if the staff member is inserted a catheter into the patient. In such cases, a staff member may inadvertently insert their hand into the X-ray beam.

### BRIEF DESCRIPTION OF DRAWINGS

Some embodiments of the disclosure will now be described, by way of example only and with reference to the accompanying drawings, in which:

FIG. 1 is a simplified schematic of a computing device that may be used to implement one or more devices according to embodiments;

FIG. 2 is a simplified schematic of a computing system that may be used to implement one or more systems according to embodiments;

FIG. 3 is a system comprising X-ray imaging apparatus and a computer system for processing captured X-ray images and for adjusting the imaging conditions of the fluoroscopy imaging apparatus;

FIG. 4 is a system comprising fluoroscopy imaging apparatus and a computer system for processing captured optical images and for adjusting the imaging conditions of the fluoroscopy imaging apparatus;

FIG. 5A illustrates the processing by an image recognition model of a series of captured images to determine whether a hand is present in each image and, if so, its location and an indication as to whether it is gloved or ungloved;

FIG. 5B illustrates the processing by two image recognition models of a series of captured images to identify hands in the images, where one of the models identifies ungloved hands and the other of the models identifies gloved hands;

FIG. 6A illustrates an example fluoroscopy image in which a region of interest is identified and a hand is detected

FIG. 6B illustrates an example of how the collimation may be adjusted to avoid directly irradiating the detected hand;

FIG. 7 illustrates an example as to how the collimation may be adjusted when part of the hand falls within the region of interest;

FIG. 8 illustrates an example as to how the collimation may be adjusted to avoid irradiating part of the hand when the hand is determined, based on captured optical images, to fall within the path of the X-ray beam;

FIG. 9 illustrates a simplified example of a feedforward neural network;

FIG. 10A illustrates a first part of a convolutional neural network for detecting the presence of a hand within a captured image;

FIG. 10B illustrates a second part of the convolutional neural network for detecting the presence of a hand within a captured image;

FIG. 11 illustrates an example U-net architecture for producing a segmentation image in which pixels belonging to a hand are indicated;

FIG. 12 illustrates a process for training a deep learning model based on labelled captured images;

FIG. 13 illustrates method for determining whether a hand is within a path of the X-ray beam and for performing an action to adjust imaging conditions in response;

FIG. 14A illustrates a method for adjusting the collimation in dependence upon whether the hand is within the region of interest;

FIG. 14B illustrates a method for selecting an action to adjust imaging conditions in dependence upon whether the hand is within the region of interest; and

FIG. 15 illustrates a method for controlling imaging quality for a region of interest.

### DETAILED DESCRIPTION

It is desirable to minimise the exposure of medical staff members to the ionising radiation used in the fluoroscopy imaging process, whilst still enabling useful images of an object to be obtained.

According to an aspect, there is provided a data processing system comprising processing circuitry configured to: obtain a series of captured images of an object, the series of captured images comprising: a series of fluoroscopy images of the object captured using an X-ray imaging apparatus; or a series of optical images of the object captured during a same time period as the series of fluoroscopy frames; provide each of at least some of the captured images to at least one image recognition model configured to determine whether a subject of a user is present in a path of an X-ray beam of the X-ray imaging apparatus; in response to detecting the subject in the path of the X-ray beam, reduce radiation provided to the subject by controlling the X-ray imaging apparatus to adjust imaging conditions including one or more: collimation of the X-ray beam provided by the X-ray imaging apparatus, the collimation limiting an area irradiated by the X-ray beam; presence of a filter between an X-ray source of the X-ray imaging apparatus and the subject; and imaging parameters of the X-ray imaging apparatus; and subsequently, in response to a predefined condition being met, controlling the X-ray imaging apparatus to further adjust the imaging conditions to increase the radiation supplied by the X-ray source to a detector of the X-ray imaging apparatus.

According to a further aspect, there is provided a computer program comprising one or more sets of computer readable instructions, which when executed by at least one processor, cause a method to be performed, the method comprising: obtaining a series of captured images of a object, the series of captured images comprising: a series of fluoroscopy images of the object captured using an X-ray imaging apparatus; or a series of optical images of the object captured during a same time period as the series of fluoroscopy frames; providing each of at least some of the captured images to at least one image recognition model configured to determine whether a subject of a user is present in a path of an X-ray beam of the X-ray imaging apparatus; in response to detecting the subject in the path of the X-ray beam, reducing radiation provided to the subject by controlling the X-ray imaging apparatus to adjust imaging conditions including one or more: collimation of the X-ray beam provided by the X-ray imaging apparatus, the collimation limiting an area irradiated by the X-ray beam; presence of a filter between an X-ray source of the X-ray imaging apparatus and the object; and imaging parameters of the X-ray imaging apparatus; and subsequently, in response to a predefined condition being met, controlling the imaging apparatus to further adjust the imaging conditions to increase the radiation supplied by the X-ray source to a detector of the X-ray imaging apparatus.

The ‘subject of the user’ may refer to a part of the body of the user/operator. The user/operator differs from the object (e.g. patient) imaged by the imaging process. The part of the body of the user/operator is not expected or intended to be imaged during the imaging process. The part of the body of the user/operator may be a hand or another part (e.g. a head) of the user/operator. In a number of the examples described herein, the subject of the user takes the form of a hand of the user. However, it is understood that, unless otherwise stated, the hand is given as an example only and that the subject of the user may take another form, e.g. the head of the user.

The system receives captured images (which may be the X-ray images themselves or optical images captured in parallel with the X-ray images) of the object and supplies these to an image recognition model to identify whether or not a subject of the user is present within the path of the X-ray beam. If so, a control signal is supplied to the imaging apparatus to cause appropriate action (e.g. collimation, filtering, or adjustment of imaging parameters) to be carried out to reduce or eliminate irradiation to the detected subject. The system subsequently determines whether a predefined condition (e.g. indicating removal of the subject from the X-ray beam) is met. The predefined condition may, for example, be a failure by the image recognition model to detect the subject in subsequent captured images. In response to the predefined condition being met, the imaging apparatus is then restored to normal operation mode (e.g. collimation or filtering is removed or imaging parameters are restored to default values). When the imaging apparatus is restored to the normal mode, the radiation supplied from the X-ray source to the detector increases again. In this way, the system with a high reliability responds to the presence of a subject in the X-ray beam by reducing the irradiation when required, but increasing image quality and size of the imaged region to a preferred level when the subject is removed.

In some embodiments, the collimation of the X-ray beam is adjusted. The collimation may be adjusted based on an identified region of the subjection. In this case, the processing circuitry of the system is configured to determine a region of the object and adjusting the collimation is performed based on a condition that the determined region of the object is irradiated by the X-ray beam. The region of the object may also be referred to as region of interest.

Embodiments will be described in more detail with reference to the accompanying Figures.

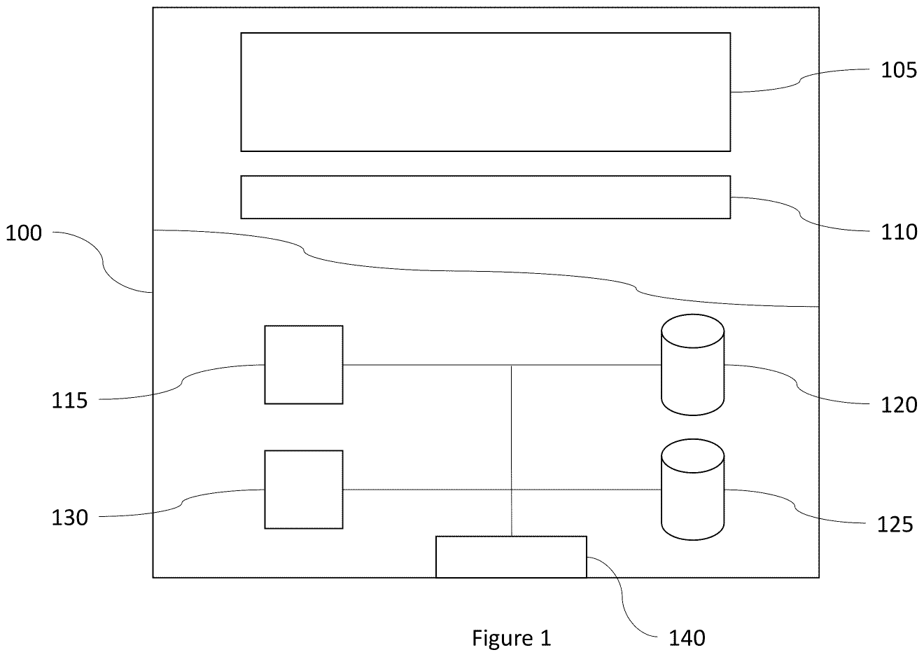

Reference is made to FIG. 1, which illustrates an example data processing system 100 in which embodiments may be implemented. The system 100 may be a server, a terminal or workstation, a personal computer (PC), or some other form of device.

The system 100 may comprise an interface 140 over which it sends and receives signals. The interface 140 may be a wired or wireless interface. For instance, the interface 140 may comprise a wired interface for connection to a wired network (e.g. a local area network and/or the internet). Alternatively or in addition, the interface 140 may comprise transceiver apparatus configured to send and receive communications over a radio interface. The transceiver apparatus may be provided, for example, by means of a radio part and associated antenna arrangement. The antenna arrangement may be arranged internally or externally to the system 100.

The system 100 is provided with at least one data processing entity 115, at least one random access memory 120, at least one read only memory 125, and other possible components 130 for use in software and hardware aided execution of tasks it is designed to perform, including control of, access to, and communications with access systems and other communication devices. The at least one random access memory 120 and the hard drive 125 are in communication with the data processing entity 115, which may be a data processor. The data processing, storage and other relevant control apparatus can be provided on an appropriate circuit board and/or in chipsets. A user may controls the operation of the system 100 by means of a suitable user interface such as key pad 110, or by voice commands. A display 105 may be included on the system 100 for displaying visual content to a user. The system 100 may also comprise a speaker for providing audio content.

The memory of the system 100 (i.e. the random access memory 120 and the hard drive 125) may be configured to store computer readable instructions for execution by the data processor 115 to perform the data processing functions described herein as being performed by the system 100. Alternatively, the components 130 may comprise hardware components, such as a field programmable gate array (FPGA) or application specific integrated circuit (ASIC), for performing the operations described herein as being performed by the system 100. In some embodiments, the operations described herein as being performed by the system 100 may be performed by a combination of the hardware components 130 or by the processor 115 executing computer readable instructions.

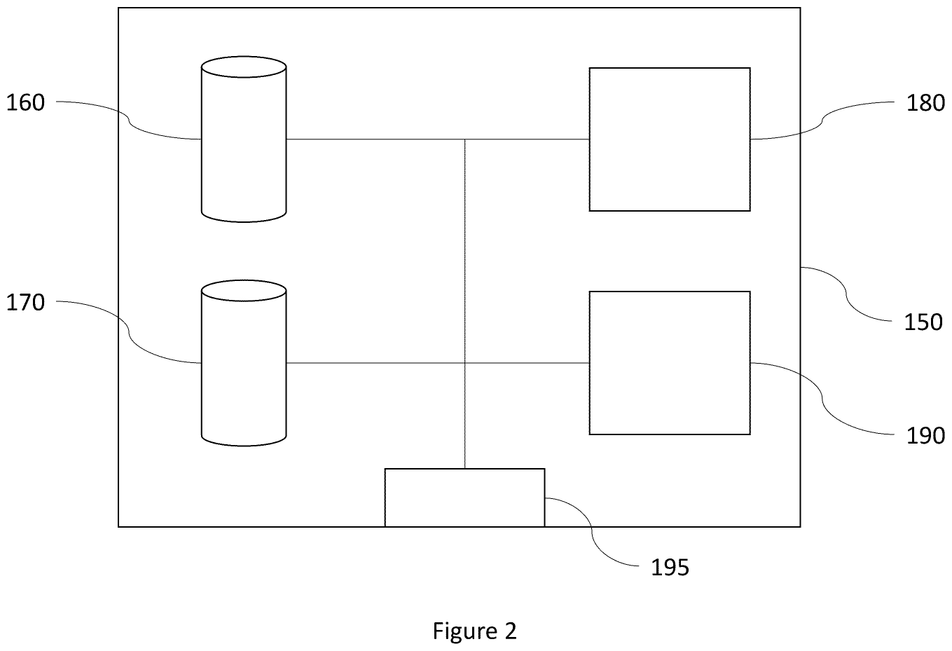

Reference is made to FIG. 2, which illustrates an example computer system 150 that may be used for performing processing described herein. In particular, the example computer system 150 may be used for performing the training of machine learning models discussed herein. Additionally or alternatively, the computer system may be used to perform the operating of machine learning models. The system 150 is shown as a single enclosed apparatus. However, in some embodiments, the system 150 is a distributed system, with multiple data processing apparatuses operating in communication with one other. The system 150 may comprise a server, back-end system, or the like.

The system 150 comprises at least one random access memory 160, at least one hard drive 170, at least one data processing unit 180, 190 and an input/output interface 195. The memories 160, 170, store data for inputting to the one or more models and for storing results of the processing performed during execution of the one or more models. In the case that one or more image recognition models discussed herein are machine learning models, the memories 160, 170 may store the training data, which is applied to train the machine learning models. The memories 160, 170 may store computer executable code which, when executed by at least one data processing unit 180, 190, provide the one or more models. At least one of the data processing units 180, 190 performs one or more of: the processing associated with the one or more models, the training of the models, and any necessary pre-processing of data for use by the models. Via the interface 195, the system 150 receives the data items for constructing the training data sets and/or the data items for constructing the operating data sets. The system 150 may additionally send via the interface 195, the results produced by running the image recognition models on input data.

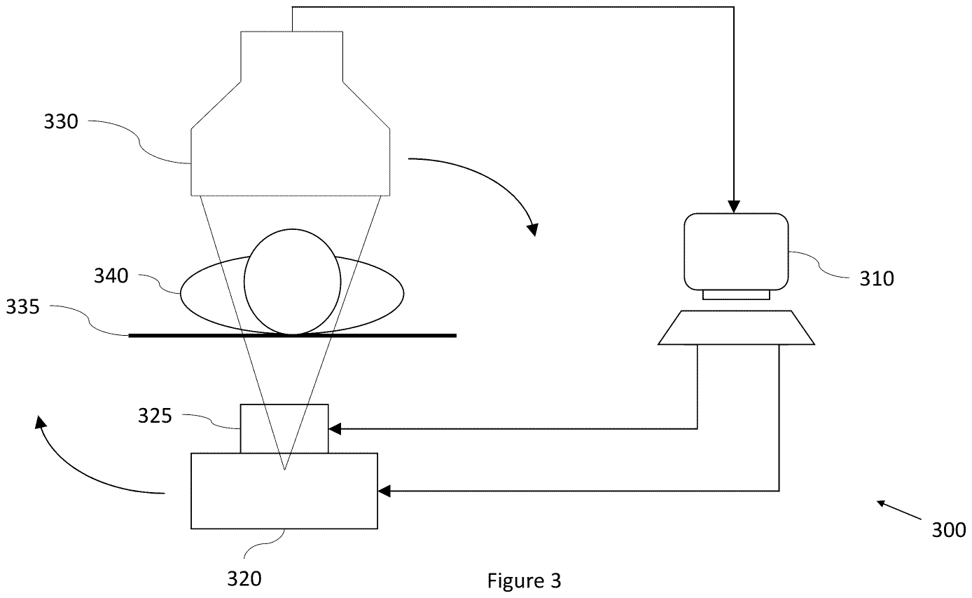

Reference is made to FIG. 3, which illustrates a system 300 comprising an X-ray imaging apparatus and a data processing system 310 connected to the X-ray imaging apparatus. The X-ray imaging apparatus comprises the X-ray tube 320 (which may also be referred to as the X-ray generator 320), the collimator 325, and the X-ray detector 330. Located between the X-ray tube 320 and the X-ray detector 330 is an object 340 lying on a table 335. The object 340 in this example is a patient who is being imaged using the X-ray apparatus. The X-ray tube 320 and X-ray detector 330 are rotatable around the patient (e.g. using a C-arm) to capture images of the object 340 and any apparatus that is present from different angles.

The X-ray apparatus is used to perform fluoroscopy imaging in which a plurality of X-ray images are produced continuously with a high level of frequency. The X-ray images function as frames of a video, having multiple frames per second. Each X-ray image is captured by the X-ray tube 320 repeatedly releasing pulses of X-rays, which are each emitted in the form of an X-ray beam towards the object 340. The X-rays of each pulse are attenuated by the object 340 and any instrument in the path of the beam, with the X-rays that are not absorbed being incident on the X-ray detector 330, resulting in an image is produced. Each pulse corresponds to one image produced at the detector 330, with the multiple pulses resulting in a series of images being captured.

Also shown in FIG. 3 is a collimator 325, which is positioned in the path of the X-ray beam emitted by the X-ray tube 320. In the description, although the term ‘X-ray tube 320’ is used, the X-ray tube may also be referred to as an X-ray source and embodiments are not limited to the X-ray source of the X-ray imaging apparatus being a particular type of X-ray source.

The collimator 325 may be used to shape the X-ray beam by blocking one or more parts of the beam emitted by the X-ray tube 320. This may be performed to limit the X-ray irradiation to certain parts of the object 340 that it is desired to image and so avoid unnecessary radiation exposure to the object 340. The collimator 325 may comprise a plurality of lead-lined blades that are used to block certain parts of the X-ray beam emitted from the X-ray tube 320 and so limit the X-ray beam to a certain field of field as required.

When performing a fluoroscopy procedure, a medical staff member (referred to hereafter as the operator) is typically present in the room where the imaging is taking place. In certain circumstances, the operator may place their hand within the X-ray beam. This is particularly likely in the case that the fluoroscopy imaging is used to enable guiding of an instrument, where that instrument may be handled/operated by the operator. An example of such an instrument is a catheter, which is inserted into the body to treat diseases or to perform a surgical procedure. A data processing system 310 is provided for detecting, on the basis of captured images, that the hand of the operator is subject to direct irradiation by the X-rays emitted from the X-ray tube 320. The data processing system 310 is provided according either of the example data processing systems 100 or 150 discussed above. The data processing system 310 is shown in FIG. 3 as taking the form of a terminal, but could be provided in another form. By analysing captured images, the system 310 determines whether a hand is within the path of the X-ray beam emitted from the X-ray tube 320. The term ‘path of the X-ray beam’ is used herein to refer to the uncollimated X-ray beam. A hand that is within the path of the X-ray beam is within the field of view of the X-ray apparatus in the case that the collimation has not been adjusted to restrict the field of view.

In the embodiment of FIG. 3, the captured images that are used to determine whether the hand is in the path of the X-ray beam take the form of the X-ray images themselves. The data processing system 310 is configured to receive the series of X-ray images produced by the detector 330 during the fluoroscopy process. Each of at least some of the images is provided to an image recognition model that is configured to determine whether a hand is present in the respective image. In some embodiments, each of the captured X-ray images may be processed by the image recognition model to determine if a hand is present. In other embodiments, only a subset (i.e. only one out of a predetermined number of frames is processed) of the captured X-ray images is processed. When the X-ray images themselves are processed as in the embodiment of FIG. 3, the data processing system 310 determines that the hand is in the path of the X-ray beam (and is therefore subject to irradiation) if a hand is detected within one of the images.

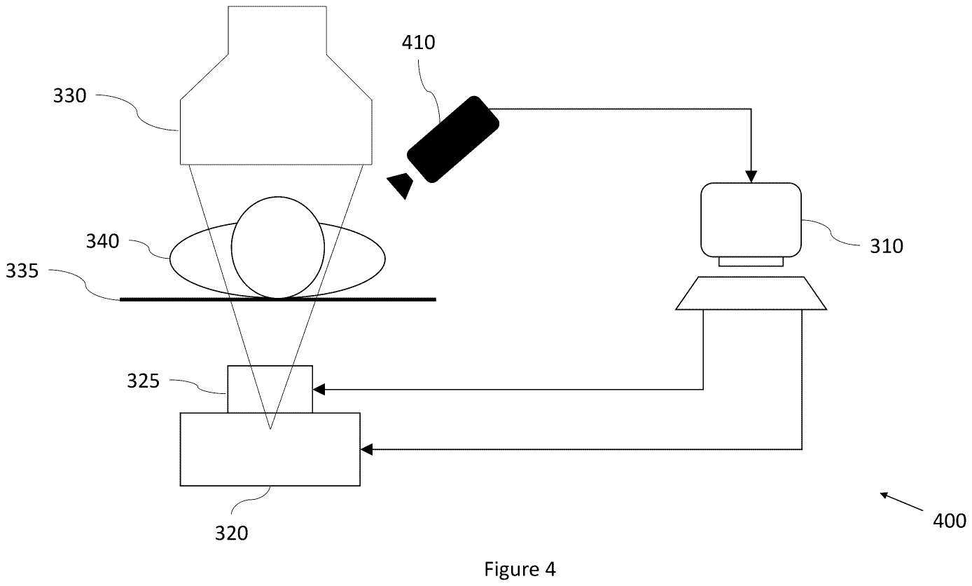

As an alternative to monitoring the X-ray images themselves for the presence of a hand, optical images may be collected and analysed to determine whether a hand is present in the path of the X-ray beam. Reference is made to FIG. 4, which shows a further system 400. The system 400 comprises the same components as the system 300, but additionally comprises a camera 410 for collecting images based on visible light. The camera 410 collects a series of images at a certain frame rate and provides these images to the data processing system 310. Since the images are collected by a camera having a different view (i.e. position, orientation, field of view) to the detector 330, the images may be subject to modification by the data processing system 310, so as to obtain an image that is limited to showing an area within the path of the X-ray beam before the images are provided to the image recognition model. The modification may comprise cropping parts of the image that show areas not falling within the path of the X-ray beam. The optical images are provided to the image recognition model, which is configured to determine whether or not a hand is present within the image. The image recognition model may additionally, if a hand is detected within this image, identify the position of the hand within the image. The data processing system 310 may then perform a mapping between the co-ordinate space of the optical image and that of the X-ray images to determine the location of the hand in the field of view of the X-ray apparatus.

In response to determining that a hand is present in the path of the X-ray beam, the data processing system 310 is configured to issue a control signal to the X-ray imaging apparatus to cause one or more actions to be performed to limit irradiation to the hand of the operator. The actions comprise adjusting the imaging conditions. The imaging conditions may comprise the collimation provided by the collimator 325, the imaging parameters of the X-ray tube 320, or the presence/absence of a filter in the path in the X-ray beam. The data processing system 310 is configured to cause one or more of these imaging conditions to be adjusted in response to determining that a hand is in the path of the X-ray beam. The effect of the one or more actions is to reduce the radiation dose supplied by the X-ray apparatus, including reducing the dose supplied to the detected hand.

Subsequently, in response to a predefined condition being met, the system 310 may adjust the imaging conditions in a manner that increases the radiation dose supplied by the X-ray apparatus. This may comprise resetting the imaging conditions to conditions before they were adjusted as discussed above. Adjusting the imaging conditions to increase the radiation supplied may comprise adjusting the collimator to increase the field of view of the X-ray apparatus, adjusting the imaging parameters (e.g. to increase the frame rate or the tube current), or removing a filter from the X-ray beam.

In some embodiments where the subject of the user is a hand, the data processing system 310 may distinguishing between an ungloved hand (i.e. a hand not wearing a radiation protection glove) and a gloved hand (i.e. a hand wearing a radiation protection glove) and perform different actions to limit irradiation to the hand in dependence upon whether the hand is a gloved hand or an ungloved hand. If the hand is identified as being an ungloved hand, the action performed by the system 310 may comprise at least one of those listed above, i.e. adjusting the collimation, adjusting the imaging parameters of the X-ray tube 320 or inserting a filter in the X-ray beam. If the hand is identified as being a gloved hand, the system 310 may comprise inhibiting an automatic exposure control function, which would normally be applied to adjust the imaging parameters to increase the dose of X-rays in the event that a high level of attenuation of X-rays is detected based on images obtained by the detector 330. A high level of attenuation of the X-rays may result from the presence of the glove within the X-ray beam, and hence result in the dose of X-rays provided by the X-ray tube 320 being increased, e.g. by increasing the tube current and thus the number of X-ray photons released in each pulse by the X-ray tube. Such an increase in X-ray dose may result in undesirable irradiation of the operator's hand (since the glove provides only partial protection) as well as an increase in dose delivered to the patient. The automatic exposure control function may, in the case that a high attenuation of X-rays is detected, be controlled and applied by the system 310 itself. However, in response to the detection of the gloved hand, the system 310 may inhibit the automatic exposure control function, such that the imaging parameters are not adjusted to increase the radiation dose, even in the event that an increase in attenuation of X-rays is detected.

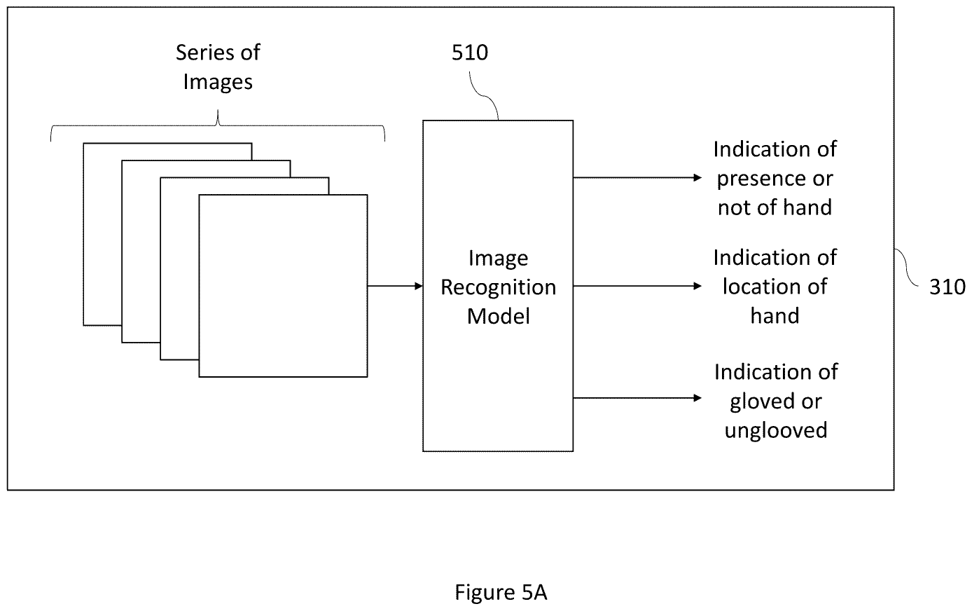

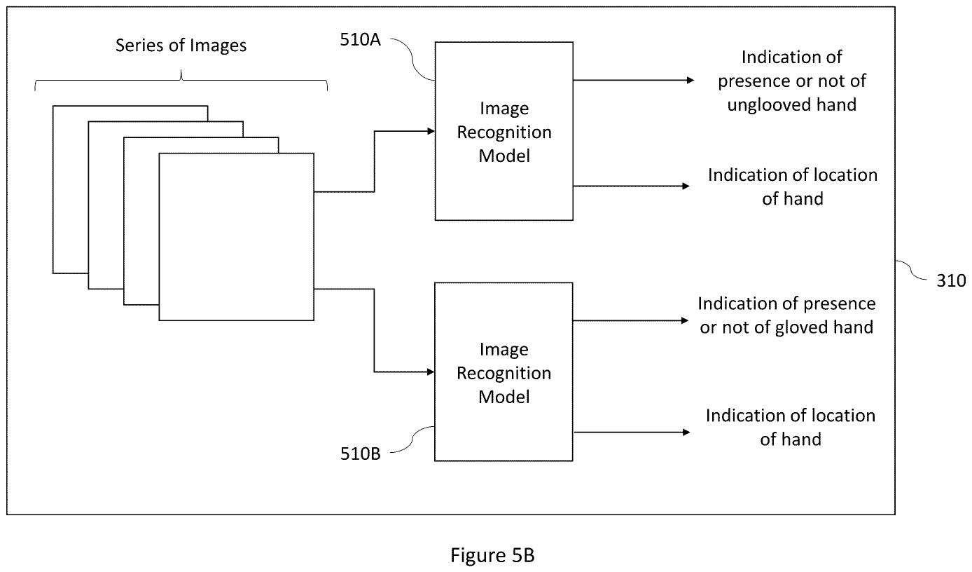

Reference is made to FIGS. 5A and 5B, which illustrates the input of images to the image recognition model 510 and the different outputs that may be obtained by the system 310 and used to determine whether and how to update the imaging conditions.

FIG. 5A illustrates a system 500 in which at least some of a series of captured images (either X-ray images or optical images) are provided as inputs to an image recognition model. FIG. 5A shows outputs that may be generated by the image recognition model 510 in response to each input image. The image recognition model 510 outputs at least an indication as to whether or not a hand is present within each image. The image recognition model 510 may further output an indication of the location of a hand that is present within the image. This indication of the location of the hand may take the form of a segmentation map, which indicates part of the image in which the hand is located. The image recognition model 510 may further output an indication as to whether a hand detected in an image is a gloved or ungloved hand.

FIG. 5A illustrates an example in which an example embodiment of the system 310 in which a single image recognition model may be used to determine whether a hand is a gloved hand or an ungloved hand. However, in other embodiments separate image recognition models may be used, where one of the models is configured to identify gloved hands in images and another of the models is configured to identify ungloved hands in images.

FIG. 5B illustrates an example embodiment of the system 310 in which two separate image recognition models are provided. A first of the image recognition models 510A is configured to identify whether or not an ungloved hand is present in each input image. A second of the image recognition models 510B is configured to identify whether or not a gloved hand is present in each input image. Each of the at least some of the series of captured images that are processed to determine whether a hand is present in that image are supplied as inputs to both models 510A, 510B to determine if a gloved hand or an ungloved hand is present in each image.

In each of the embodiments shown in FIGS. 5A and 5B, in the case that the captured images that are processed are optical images captured by the camera 410, the indication of the location of the hand that is output by one of the models 510, 510A, 510B may be subject to further processing to determine an indication of the location of the hand within the respective X-ray image. Once the location of the hand within one or more of the X-ray images (and therefore within the field of view of the X-ray apparatus) is determined, the system 310 may send a control signal to the collimator 325 to cause the collimator to block irradiation to at least part of the hand based on the determined location.

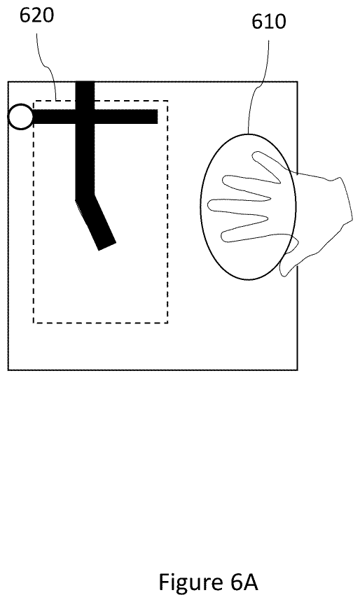

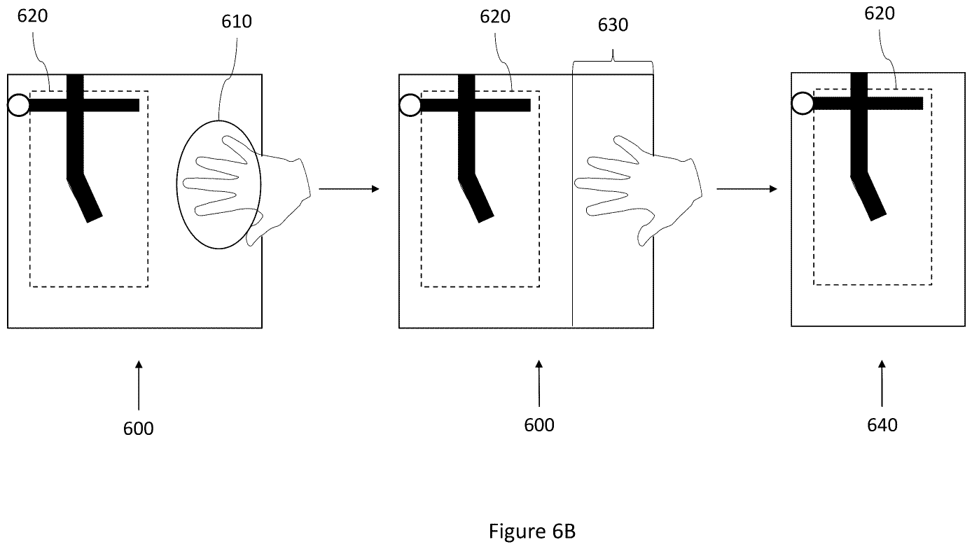

Reference is made to FIG. 6A, which illustrates an example X-ray image 600 in which a hand is present in the image 600. The image 600 shows a catheter tube shown in a region of interest 620. The image 600 also shows a hand located within an area 610 of the image. The image 600 may be provided as an input to the image recognition model to obtain an indication that the hand is present within the image 600. The image recognition model may output an indication, not only that the hand is present within the image 600, but also output an indication of the location of the hand within the image 600. In response to the detection of the hand, the system 310 causes an action that causes the radiation to the hand to be reduced. This action may be global in nature, i.e. the amount of radiation across the entire field of view of the X-ray apparatus may be reduced. This can be achieved by adjusting the imaging parameters of the X-ray tube—e.g. the tube current—and frame rate. Adjusting the frame rate may be achieved by reducing the rate at which pulses of X-rays are generated by the X-ray generator 320. Alternatively, the action may be achieved by adjusting the collimation, so as to limit the field of view of the X-ray apparatus so as to avoid irradiating a region containing the hand.

Reference is made to FIG. 6B, which illustrates an example in which the collimation is adjusted to reduce the amount of radiation provided to the hand. When the Image 600 is input to the image recognition model, the image recognition model determines part of the image 600 in which the hand is included. In the example of FIG. 6B, this part of the image is shown as an area 610, which includes the hand, but also includes pixels of the image 600 that correspond to parts of the image other than the hand. However, in some embodiments, the image recognition model may perform segmentation of the image 600 to identify the pixels belonging to the hand.

Once the part of the image 600 including the hand has been identified, the system 310 may determine an area 630 of the image 640 containing the hand that corresponds to areas to be removed from subsequent images by adjusting the collimation. This region area 630 is bounded by vertical or horizontal lines extending across the image 600, hence having a rectangular shape. The area 630 corresponds to a region to be removed from subsequent images captured by the X-ray apparatus by using the collimator to prevent irradiation of that region. In response to identifying the area 630, the system 310 sends a control signal to the collimator 325 to cause the blades of the collimator 325 to block radiation at angles corresponding to the area 630 of the image 600. Example image 640 represents a subsequently captured image in which the collimation has been updated. In this case, the image 640 does not contain any imaging data corresponding to the region represented in area 630.

In some embodiments, the system 310 may determine the area 630 to which collimation is to be applied based not only on the detection of the hand within this area 630, but also based upon the identification of a region of interest 620 represented within the image 600. The region of interest 620 represents an area that is of interest to the operator and for which it is critical to obtain imaging data, e.g. for inserting an instrument, performing surgery, or diagnosing a patient. The region of interest 620 may be specified by user input by the operator of the system 310. Alternatively, the region of interest 620 may be determined by the system 310 applying a further image recognition model to one or more of the captured fluoroscopic images. Once the region of interest 620 is identified, the area 630 of the image for which collimation is to be applied may be determined based on the condition that the area 630 should not overlap with the region of interest 620. In the example of FIG. 6B, the hand shown in the image 600 does not intersect the region of interest 620. Therefore, the entire hand may be removed from the further image 640, whilst still imaging the full region of interest 620.

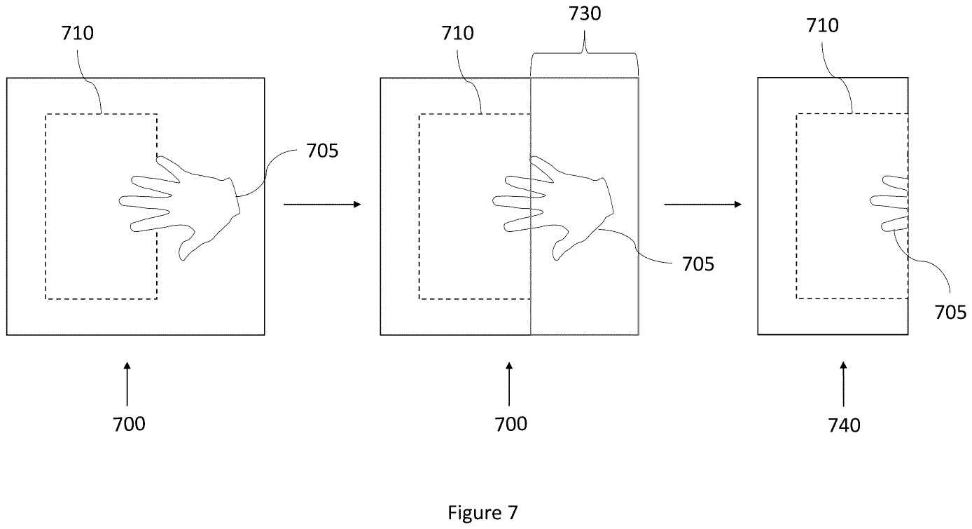

In some circumstances, the hand may intersect a determined region of interest that is subject to fluoroscopy imaging. In this case, the system 310 may determine an area to which collimation is to be applied that includes only part of the hand, where the part of the hand falls outside of the region of interest. Reference is made to FIG. 7, which illustrates the processing of example images captured in such circumstances. FIG. 7 shows a first captured image 700, which contains imaging data of a hand 705 and imaging data within a region of interest 710. As shown, within the image 700, the hand 705 overlays the region of interest 710. The system 310 detects the location of the hand 705 and determines an area 730 of the image for which collimation is to be applied. The system 310 determines an area 730 containing the part of the hand 705 that is not within the region of interest 710. The system 310, therefore, limits the area 730 that is to be subject to collimation, so that it does not include any part of the region of interest 710, even if the area 730 does not include the entire hand 705. Having determined the area 730, the system 310 controls the collimator 325 to prevent irradiation of the region corresponding to area 730 in image 700. FIG. 7 shows a further image 740 obtained by the X-ray apparatus when the modified collimation is applied. As shown in FIG. 7, part of the hand 705 that lies within the region of interest 710 is still captured in the image 740.

In further embodiments, when the system 310 determines that part of the detected hand falls within the region of interest, rather than adjust the collimation, the system 310 may perform one or more of the actions to globally reduce the amount of radiation emitted across the entire field of view by the X-ray generator 320. These actions comprise adjusting the imaging parameters (e.g. tube current or frame rate) to reduce the amount of X-ray radiation produced by the generator 320 or the insertion of a filter into the path of the X-ray beam.

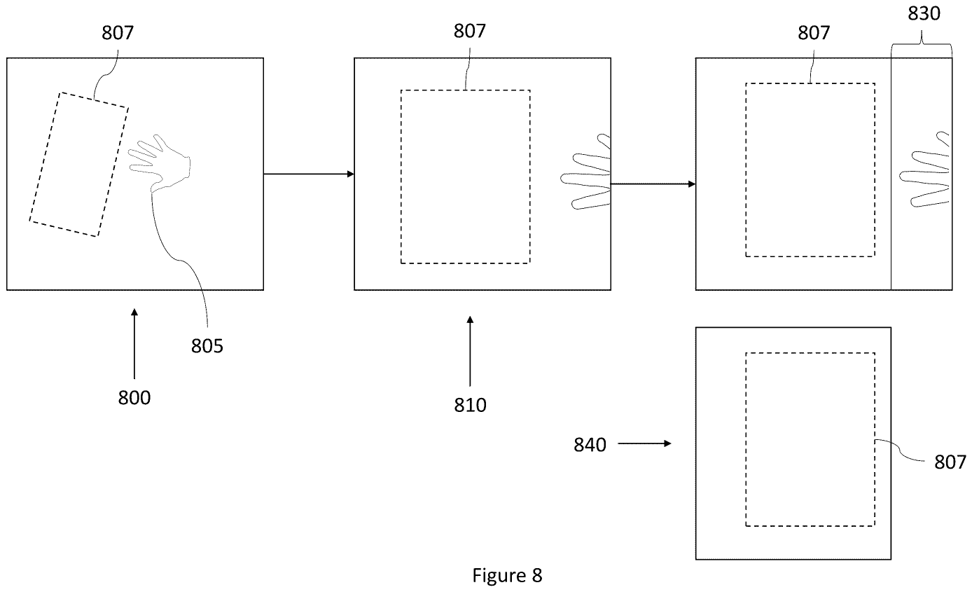

As discussed, in some embodiments, the captured images that are subject to processing to determine whether a hand falls within the path of the X-ray beam are optical images captured by camera 410. In this case, the captured image may be subject to a transformation to produce an image showing a region falling within the path of the X-ray beam. FIG. 8 shows an example image 800 captured by the camera 410. The image 800 includes a determined region of interest 810 for the fluoroscopy imaging as well as an operator hand 805. The image 800 may include image data corresponding to objects outside of the field of view of the X-ray apparatus. The image 800 may be provided as an input to the image recognition model to identify the presence and location of the hand 805 within the image. Once the location is determined, to determine how the collimation should be adjusted to avoid irradiating the detected hand, the system 310 may performing a mapping of the image into the field of view of the X-ray apparatus. This perform the mapping, the system 310 applies a transform (e.g. a rotation in the example of FIG. 8) and crops part of the image 800 showing areas falling outside of the field of view of the X-ray apparatus. The resulting image 810 provides an optical image of the region within the field of view of the X-ray apparatus and in a co-ordinate space of the X-ray images captured by that apparatus. The hand position is mapped as part of this process and so the position of the hand 805 in the X-ray field of view is determined by the system 310. On the basis of the hand position within image 810, the system determines an area 830 containing the hand 805 and sends a control signal to the collimator 325 to cause the collimator 325 to prevent irradiation of the hand by limiting the field of view of the X-ray apparatus to exclude area 830. FIG. 8 shows an X-ray image 840 captured by the X-ray apparatus after the adjustment of the collimation of the collimator 325. As a result of adjustment of the collimation, the region corresponding to the identified area 830 is not irradiated by the X-ray generator 320 and is excluded from the generated image 840.

It has been described that, in the case that optical images are captured and used to identify the location of a hand in the field of view of the X-ray apparatus, that the optical image is first subject to processing by the image recognition model to identify the presence and location of a hand within the image, and that a transformation is then applied to determine the location of the hand in the field of view of the X-ray apparatus. However, it is not excluded that one or more aspects of the transformation (e.g. cropping the image) may be applied to the optical image prior to processing the optical image using the image recognition model to identify the presence and location of a hand within the image.

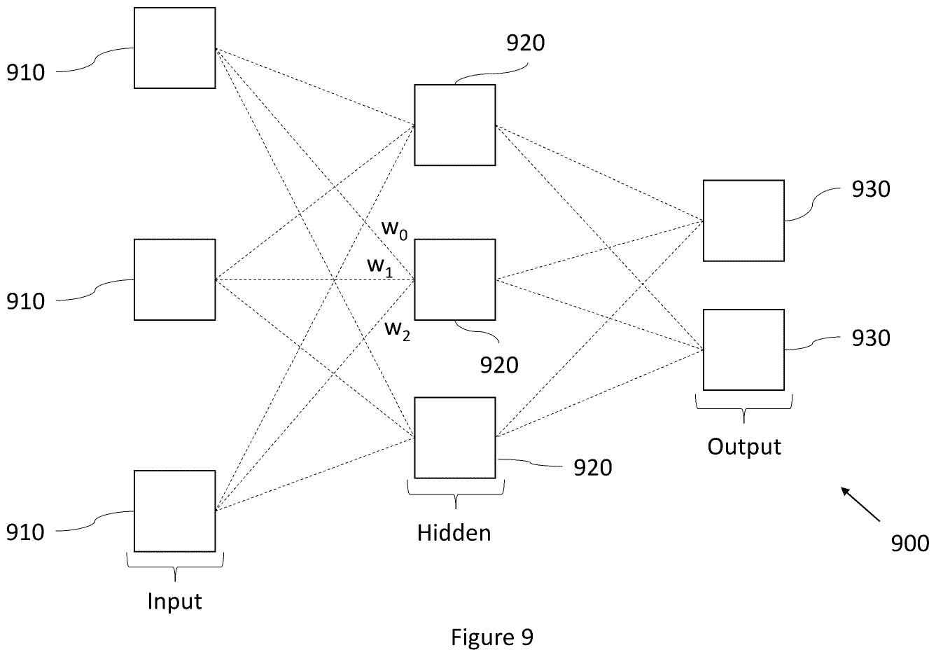

An image recognition model has been discussed in the context of various embodiments. This image recognition model may take multiple different forms. Specifically, the image recognition model may take the form of a computer vision processing module, e.g. which uses feature extractors to determine the presence of a hand within an image supplied to the module. Alternatively, the image recognition model may take the form of a deep learning model, which is trained to identify the presence of hands in an image and may be trained to identify their location within the location. With respect to FIGS. 9 to 11, some of the concepts that may be applied to provide the recognition model for identifying hands in the captured images are discussed.

FIG. 9 as a schematic illustration of a neural network 900. The neural network 900 comprises input nodes 910, hidden nodes 920 and output nodes 930. In practice, there are likely to be many more nodes in the network 900 than those shown, and more hidden layers than the one shown. Each input node 910 receives a single value of the input data and produces at its output, an activation or node value, which is generated by supplying the input value to an activation function (e.g. a sigmoid). Each of the input nodes 910 is connected to each of the hidden nodes 920. A matrix of weights defines the connectivity between the input nodes 910 and the hidden nodes 920. A vector of the node values output from the input nodes 910 is scaled by a vector of respective weights at the input of each of the hidden nodes 920, each weight defining the connectivity of one of the input nodes 910 with a connected one of the hidden nodes 920. The weights applied at the inputs of one of the hidden nodes 920 are shown in FIG. 9 as w₀ . . . w₃. At each hidden node 920, the input value at that node is given by the dot product of its associated weights vector and the output values of the input nodes 910. The activation function is then applied to the input values at the hidden nodes 920 to provide the output values of those nodes 920. The output vector of the hidden nodes 920 is supplied to each of the nodes 930 in the next layer of the network 900 and used in a similar manner to generate the output values for that next layer.

The network 900 may be trained through supervised or unsupervised learning. In one embodiment, the network 900 is trained through supervised leaning by determining at least one set of output values based on at least one set of input values included in the training data. The output values are compared to known labels in the training data and an error or loss is calculated (i.e. based on a difference between the output values and the labels). The error or loss is then back-propagated through the network 900 to update the weights, such that the network 900 is trained to better approximate the labels from the input values. In the next cycle, the revised weights are used with further training data to further update the weights to more closely reproduce the labels of the further training data based on the input values of the further training data. In this way, the network 900 can be trained to perform a specific task.

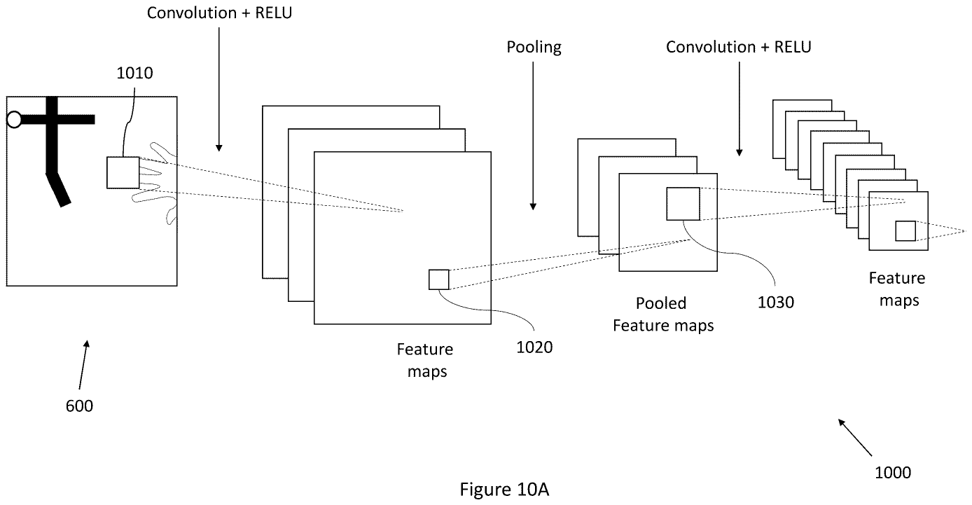

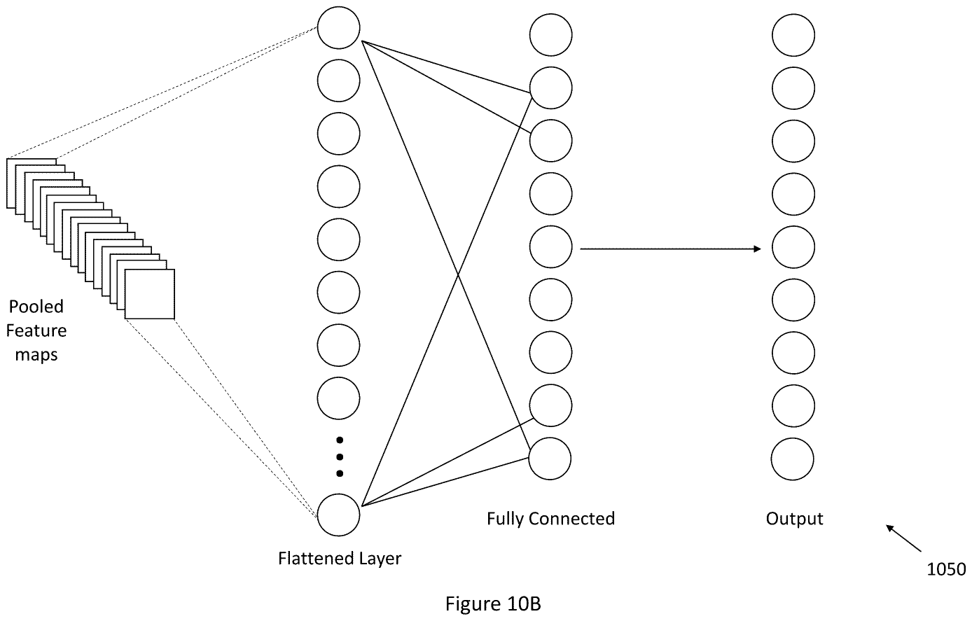

Reference is made to FIGS. 10A and 10B, which illustrate an example of the operation of a convolutional neural network (CNN), which can be used to identify certain features within images and perform classification of those features. In the example shown, the input image is the X-ray image 600 from the example discussed above with respect to FIGS. 6A and 6B, but could be another X-ray image or an optical image. The convolutional neural network may be used to derive a set of output values indicating the presence or absence of a hand within the image 600 and an indication of a part of the image 600 containing the hand. FIG. 10A shows a first part 1000 of the CNN, whilst FIG. 10B shows a second part 1050 of the CNN.

A kernel 1010 is applied to determine a convolution of the input image 600 with the kernel 1010. The output of this convolution is subject to an activation function to add non-linearity. The activation function used in FIG. 10A is a rectified linear activation unit (RELU) which, if the input is positive, outputs the input and, if the input is not positive, outputs zero. A plurality of feature maps are generated from the input image by performing convolutions between the input image and different kernels, where each kernel represents a different basic feature, e.g. a vertical line or horizontal line.

Each of the feature maps produced by the convolution and activation function is then subject to a pooling process, which is performed to reduce the spatial size of the convolved feature. The pooling process involves translating a kernel 1020 across the feature map to sample groups of pixels and returning the maximum or average value from each of the sampled groups of pixels in the feature map. The resulting pooled feature maps are each subject to a further convolution process (with the RELU function applied) using the different kernels to generate a further set of feature maps from which pooling is again performed.

As shown in FIG. 10B, the pooled feature maps resulting from multiple stages of convolution and pooling are flattened to produce a one dimensional array (shown as Flattened Layer), which is provided as a set of input values to a feed forward neural network. The resulting output values may represent the classification (i.e. hand or not hand) of different parts of the input image 600. The system 310 may convert these output values to a classification map for the image 600.

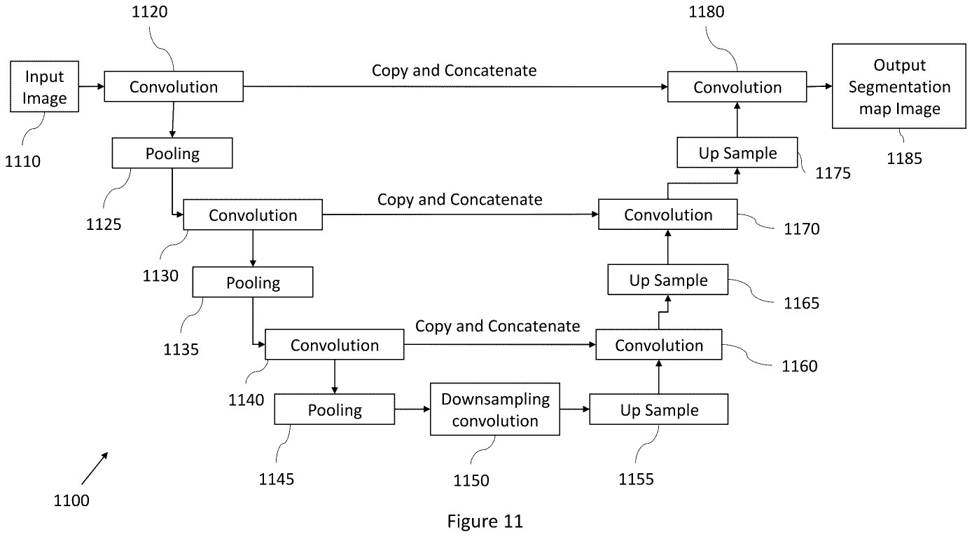

In some embodiment, CNN/s may be applied by the system 310 to perform segmentation of a captured image, so as to identify which pixels of the image are pixels representing the hand. This segmentation may be performed using a U-net model. Reference is made to FIG. 11, which illustrates an example of a U-net model 1100 for performing segmentation of an input image 1110.

The U-net 1100 receives the input image 1110, which is applied to the downsampling convolution stage 1120. The downsampling convolution stage 1120 performs convolutions on the input image 1110 and applies an activation function to generate a set of feature maps. A part of each feature is stored to be concatenated with a further feature map in a latter part of the process. The pooling process 1125 is applied to the feature maps resulting from the convolutions to generate pooled feature maps. The convolution and pooling processes are repeated to further downsample the data at stages 1130, 1135, 1140, 1145, 1150.

In a second part of the network 1100, the pooling modules 1125, 1135, 1145 are replaced with up sampling stages 1155, 1165, 1175. Between the upsampling stages 1155, 1165, 1175 are a set of convolution stages 1160, 1170, 1180, at which a convolution is applied. Each convolution stage 1160, 1170, 1180 is applied to a result of concatenating an output of an earlier convolution stage 1120, 1130, 1140, with the output of a preceding upsampling stage 1155, 1165, 1175.

The result of the processing by the U-net 1110 is the output image 1185, which represents a segmentation map of the input image in which the pixels representing the hand are provided with different values to the pixels not representing the hand.

The image recognition model applied by the system 310 to determine the presence of a hand and its location in the image may be a deep learning model that takes the form of either the CNN discussed above with respect to FIG. 10A or 10B or the CNN 1100 discussed above with respect to FIG. 11.

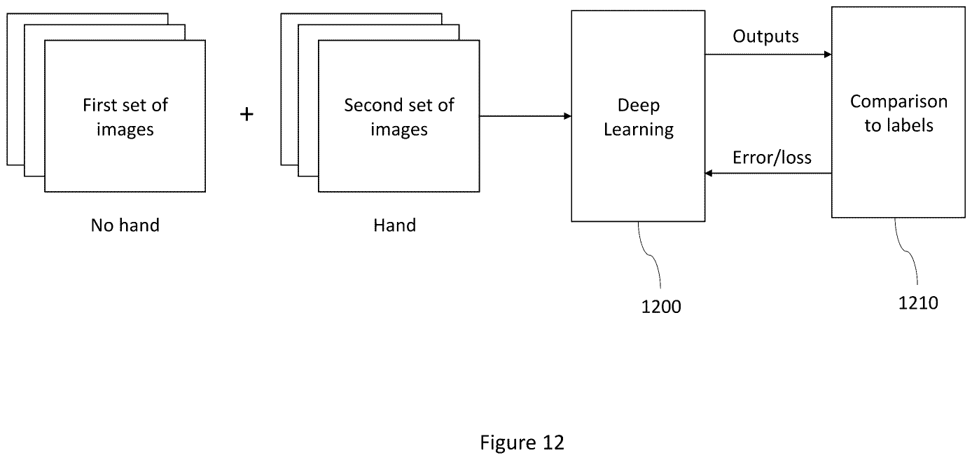

Reference is made to FIG. 12, which illustrates a process for training the image recognition model when the model takes the form of a deep learning model 1200 (e.g. one of the CNNs discussed above). The process is implemented on a data processing system, which may take the form of a system 100 or system 150. To train the model 1200, a plurality of captured images are provided to the system. The images may be X-ray images or optical images depending upon whether the model 1200 is being trained to recognise hands in one type of image or the other. Each of the images have been labelled by a human user to indicate whether or not a hand is present in the image and, if so, its location within the image. FIG. 12 shows a first set of images labelled as showing cases in which no hand is present in the image and a second set of frames labelled as showing cases in which a hand is present in the image. Each of those set of frames are input by the system 150 to the model 1200 to derive a set of outputs. For each of the images, the outputs are compared to the corresponding label at a comparison stage 1210 to determine an error/loss, which is then used to update the parameters of the model 1200. In some embodiments, the second set of images may be further labelled to indicate whether the hand is gloved or ungloved and the model 1200 trained to distinguish between gloved and ungloved hands.

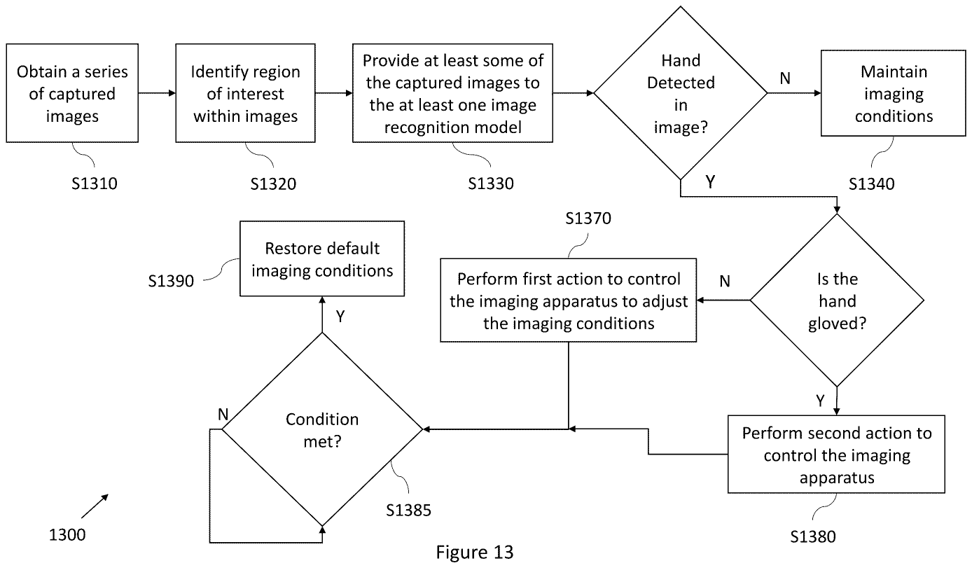

Reference is made to FIG. 13, which illustrates a method 1300 for adjusting the imaging conditions based on whether or not a hand is detected in the path of the X-ray beam.

At S1310, a series of captured images are obtained. The series of captured images include the X-ray images obtained by the X-ray detector 330 during fluoroscopy imaging and may also include the optical images obtained during the fluoroscopy imaging by the camera 410.

At S1320, the system 310 determines a region of interest (e.g. region of interest 620) within each of the X-ray images. The system 310 may determine the region of interest in response to user input highlighting the region of interest or may determine the region of interest by applying image recognition processing to one or more of the X-ray images.

At S1330, at least some of the captured images are provided to the image recognition model, which performs processing of the images to determine whether a hand is present within the image and, therefore, whether the hand is in the path of the X-ray beam. This processing may be performed by a machine learning model or a classical image recognition algorithm. If a classical image recognition is applied by the system 310, this may operate by detecting bones within the fingers.

If a hand is not detected in one of the captured images, the method 1300 proceeds to S1340 at which the imaging conditions used for the fluoroscopy imaging are maintained by the system 310. If a hand is detected, the system 310 causes the imaging conditions to be adjusted.

In embodiments, and as shown in FIG. 13, the method 1300 comprises, when a hand is detected in one of the captured images, determining whether the hand is gloved or ungloved. If the hand is determined to be ungloved, the method 1300 proceeds to S1370 at which a first action to control the imaging apparatus to adjust the imaging conditions is performed. If the hand is determined to be gloved, the method 1300 proceeds to S1380 at which a second action to control the imaging apparatus to adjust the imaging conditions is performed. The first action performed at S1370 may comprise one or more of: adjusting the collimation of the collimator 325 so that at least part of the hand is no longer included in the field of view of the X-ray apparatus, inserting a filter into the path of the X-ray beam, or adjusting the imaging parameters of the X-ray generator 320. The second action performed at S1380 may comprise any of the same types of action (i.e. adjusting collimation, imaging parameters, filters) discussed above in relation to the first action. Additionally or alternatively, the second action may comprise inhibiting an automatic exposure control function from increasing the intensity of X-ray radiation emitted by the X-ray tube 320.

After one or more actions have been performed at either S1370 or S1380 to reduce the radiation exposure of the hand, the system 310, at S1385, determines whether or not at least one predefined condition has been met. The at least one predefined condition being met may be indicative of the hand being removed from the path of the X-ray beam. At S1385, the system 310, may determine whether a plurality of different conditions (examples of which are discussed below) are met and may proceed to S1390 in response to one of these plurality of conditions being met.

S1385 may be performed by supplying further captured images to the image recognition model to determine whether the hand is present within the path of the X-ray beam. In this case, the further captured images may comprise optical images captured by the camera 410. Alternatively, in the case that the collimation is not adjusted to exclude an area in which the hand is present from the field of view of the X-ray apparatus, the further captured images may comprise X-ray images captured by the detector 330. If the system 310 determines based on the captured images that a hand is no longer within the path of the X-ray beam, the method proceeds to S1390.

S1385 may be performed based on determining whether the X-ray apparatus has been rotated, since the determination that a hand was present in the image. As discussed, the X-ray apparatus may be rotated about the subject with rotation of the C-arm to which the apparatus is attached. The X-ray apparatus may output a signal to the system 310 indicating the orientation of the X-ray apparatus so that the system 310 can detect when the apparatus is rotated. Alternatively, the system 310 may itself control the rotation of the X-ray apparatus. If a S1385, the system 310 determines that the X-ray apparatus is being rotated about the object 340, the method 1300 proceeds to S1390.

S1385 may be performed based on a determination of whether a manual indication has been supplied by user input. In other words, a user may provide input at a user interface of the system 310 following adjustment of the imaging conditions to cause the imaging conditions to be restored to the default values at S1390.

S1385 may be performed based on a determination as to whether a predefined amount of time has expired since one of the actions (e.g. at S1370 or S1380) was performed to adjust the imaging conditions. In response to determining that the predefined amount of time has expired, the method 1300 proceeds to S1390.

At S1390, the system 310 sends control signals to the X-ray apparatus to modify the imaging conditions to increase the radiation supplied by the X-ray source 320 to the detector 330. S1390 may comprise controlling the X-ray apparatus to restore the imaging conditions to their previous conditions (i.e. the default conditions) prior to one or more of the actions (e.g. the first action at S1370 or the second action at S1380) being performed to restore the default imaging conditions. S1390 may comprise re-adjusting the collimation of the collimator 325 to increase the field of view of the X-ray apparatus to include areas that were previously excluded as a result of adjusting (e.g. at S1370 or S1380) the collimation when the hand was detected. S1390 may comprise adjusting the imaging parameters to increase the intensity of X-rays belonging to each pulse output by the X-ray tube 320 or to increase the frame rate of the X-ray apparatus. S1390 may comprise removing a filter that was previously applied to the X-ray beam.

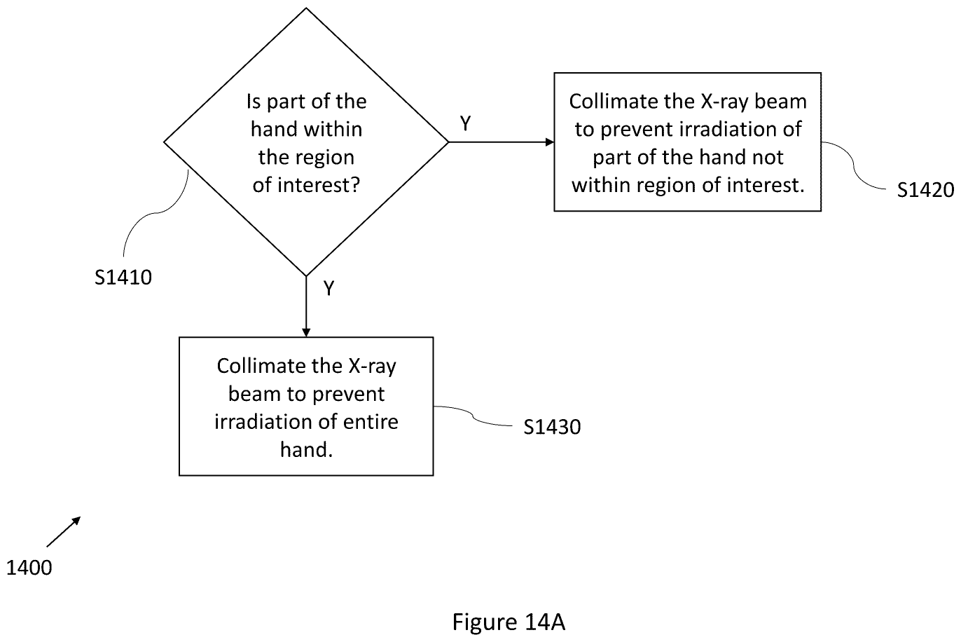

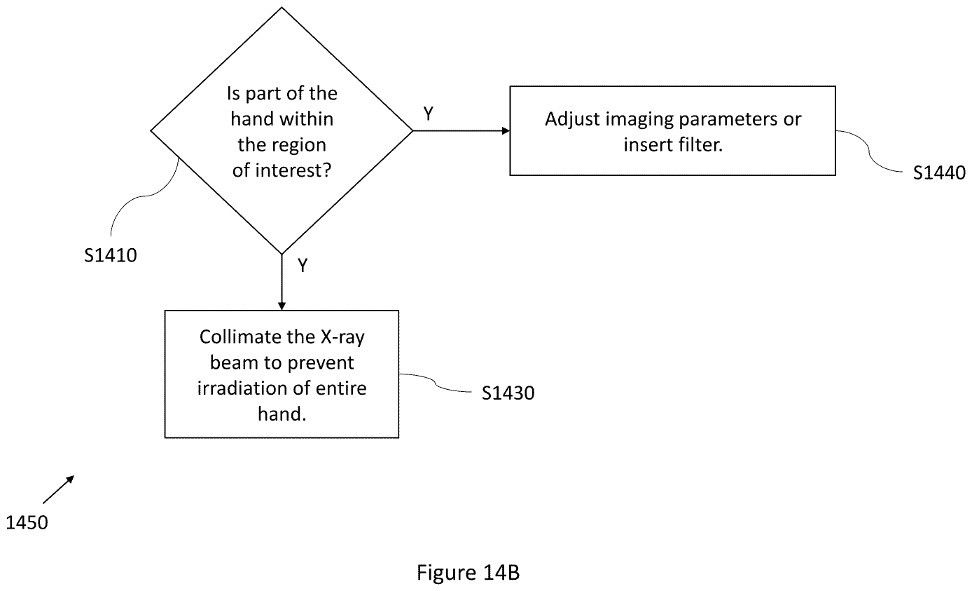

In some embodiments, when the action performed (either at S1370 or S1380) comprises adjusting the collimation of the X-ray beam, this adjustment may be performed in dependence upon the region of interest determined at S1320. In particular, the adjustment is performed to avoid restricting the field of view to exclude any part of the region of interest. In some cases, part of the detected hand may fall within the region of interest. Reference is made to FIG. 14A, which illustrates steps of method 1400 for performing the adjustment of collimation when that adjustment is performed in dependence upon the determined region of interest.

At S1410, the system 310 determines whether or not part of the hand falls within the region of interest. If so, the method 1400 proceeds to S1420 at which the system 310 issues a control signal to cause the collimation to be adjusted to prevent irradiation of the other part of the hand not within the region of interest. If not, the method 1400 proceeds to S1430 at which the system 310 issues a control signal to cause the collimation to be adjusted to prevent irradiation of the entire hand.

In an alternative embodiment, when part of a hand is detected within the region of interest, rather than collimating the X-ray beam to prevent irradiation of part of the hand, the system 310 may determine to adjust the imaging conditions by adjusting the imaging parameters or applying a filter. Reference is made to FIG. 14B, which illustrates an alternative method 1450. In this method, the steps S1410 and S1430 are the same as those shown in FIG. 14A. However, instead of the step of adjusting the collimation at S1420, the method 1450 includes at S1440, the step of adjusting imaging parameters or inserting a filter.

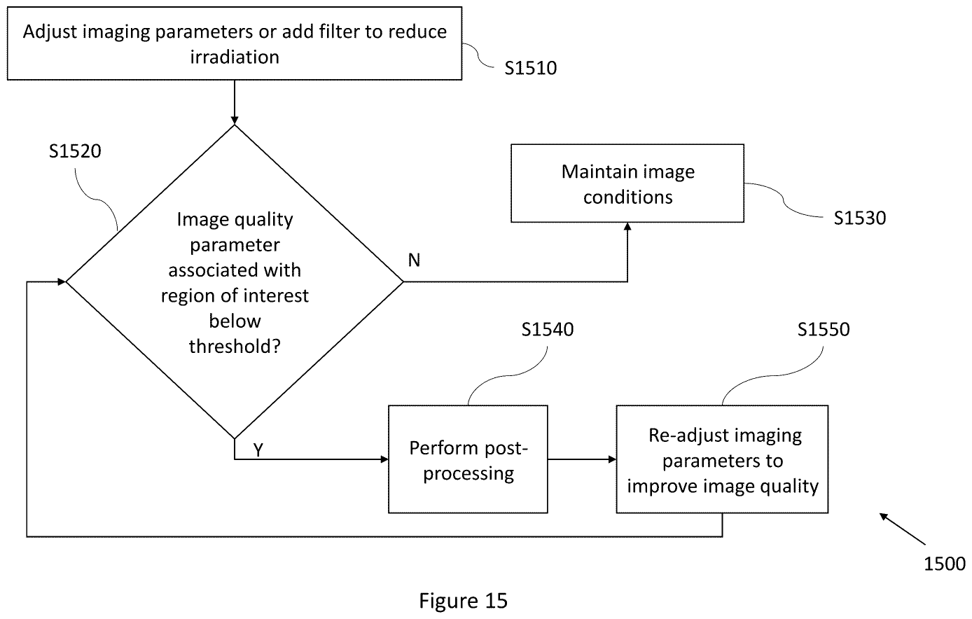

In some embodiments, when the imaging parameters are adjusted or a filter is used to reduce radiation supplied to a hand, the system 310 may monitor the image quality associated with the region of interest to ensure that the image quality within this region remains above a certain level. Reference is made to FIG. 15, which illustrates a method 1500 for ensuring that the image quality within the region of interest remains above a certain level. The method may 1500 may be performed as part of steps (e.g. S1370 or S1380) performed to adjust the imaging conditions in response to detection of a hand.

At S1510, the system 310 adjusts the imaging parameters or adds a filter so as to reduce the intensity of radiation output from the generator 320 to the object 340. At S1520, the system 310 measures a parameter (the ‘image quality parameter’) indicating the quality of the images of the region of interest captured by the X-ray detector 330. The image quality parameter may be a parameter indicating the overall level of noise within the image of the region of interest, the signal to noise ratio within the image of the region of interest or the image contrast with the image of the region of interest. At S1520, the system 310 determines whether or not this image quality parameter is below a threshold. If the imaging parameter is not below the threshold, the system 310 may, at S1530, maintain the current imaging conditions. If the imaging parameters are below the threshold, the system 310 may perform one or more actions at S1540 and/or S1550 to improve the imaging quality.

At S1540, the system 310 may performs post-processing of the X-ray images to compensate for the reduction in image quality as a result of S1510. This post-processing may comprise performing de-noising or digital filtering of the images to improve the signal to noise ratio (SNR). Additionally or alternatively, at S1550, the system 310 may re-adjust the imaging parameters to improve image quality by increasing the amount of radiation transmitted from the generator 320 to the object 340.

Once the actions at S1540 and/or S1550 have been performed to improve the image quality, the system at S1520 may determine the image quality parameters for the region of interest in subsequently captured X-ray images and, if the image quality parameters are still below the threshold, may again perform S1550 to increase the radiation supplied to the object 340 so as to improve the image quality.

The image quality parameters adjusted at S1510 and at S1550 may include the tube current of the generator 320 and the frame rate of the generator 320.

Implementations of the subject matter and the operations described in this specification can be realized in digital electronic circuitry, or in computer software, firmware, or hardware, including the structures disclosed in this specification and their structural equivalents, or in combinations of one or more of them. For instance, hardware may include processors, microprocessors, electronic circuitry, electronic components, integrated circuits, etc. Implementations of the subject matter described in this specification can be realized using one or more computer programs, i.e., one or more modules of computer program instructions, encoded on computer storage medium for execution by, or to control the operation of, data processing apparatus. Alternatively or in addition, the program instructions can be encoded on an artificially generated propagated signal, e.g., a machine-generated electrical, optical, or electromagnetic signal that is generated to encode information for transmission to suitable receiver apparatus for execution by a data processing apparatus. A computer storage medium can be, or be included in, a computer-readable storage device, a computer-readable storage substrate, a random or serial access memory array or device, or a combination of one or more of them. Moreover, while a computer storage medium is not a propagated signal, a computer storage medium can be a source or destination of computer program instructions encoded in an artificially generated propagated signal. The computer storage medium can also be, or be included in, one or more separate physical components or media (e.g., multiple CDs, disks, or other storage devices).

According to various embodiments, there is provided a medical imaging apparatus comprising: (a) a fluoroscopy system containing an X-ray emitter, detector panel and collimation/filtering hardware; (b) An image processing module configured to identify operator hands within the X-ray beam; (c) A mechanism to modulate exposure to reduce radiation dose to the operator based on output from the image processing module; (d) A mechanism to return the system to normal operation after operator hands have been removed from the beam area. In some of the further embodiments, hands are detected by analysis of fluoroscopy images from the detector panel (for example by deep learning). In some of the further embodiments, hands are detected by analysis of images from an auxiliary camera positioned close to the X-ray emitter. In some of the further embodiments, in which exposure is modulated by adjusting collimators to reduce the X-ray beam area. In some of the further embodiments, a region of interest is specified, and collimation will never exclude any of the ROI. In some of the further embodiments, exposure is modulated by globally reducing image quality (for example by introducing additional filters, reducing tube current, reducing framerate). In some of the further embodiments, exposure is modulated by globally reducing image quality (for example by introducing additional filters, reducing tube current, reducing framerate). In some of the further embodiments, a specified region of interest is monitored for image quality, to ensure that image quality in the ROI never drops below an acceptable level. In some of the further embodiments, exposure may be further modulated by reducing image quality only if hands are detected within the ROI. In some of the further embodiments, image quality in the ROI is permitted to drop below the acceptable level only if hands are detected within the ROI. In some of the further embodiments, the system is returned to normal operation by manual (hardware or software) intervention. In some of the further embodiments, the system is returned to normal operation automatically after a specified time. In some of the further embodiments, the system is returned to normal operation based on continued monitoring of the auxiliary camera. In some of the further embodiments, the system is returned to normal operation based on continued monitoring of the degraded images. In some of the further embodiments, the image processing module additionally detects whether the operator is wearing radiation-attenuating gloves. In some of the further embodiments, X-ray exposure is controlled by an automatic exposure control (AEC) system, and the presence of radiation-attenuating gloves inhibits the AEC system from increasing exposure.

According to various embodiments, there is provided a X-ray diagnosis apparatus comprising: processing circuitry configured to acquire X-ray image or optical image related to patient, detect target object its exposed dose should be reduced, within the X-ray image or optical image, determine Region of Interest (ROI) within the X-ray image or optical image using ROI information determine irradiated area, the irradiated area is set to avoid radiation to the target object and set to execute radiation to the ROI; and control position of corresponding X-ray aperture blade or filter to form the irradiated area. In some of the further embodiments, the X-ray diagnosis apparatus is further configured to notify information of the detected target to user, if there is no position change of the target object between a plurality of acquired X-ray image or acquired optical image, control position of the corresponding X-ray aperture blade or filter to form the irradiated area. In some of the further embodiments, the X-ray diagnosis apparatus is further configured to after a set time has passed from notifying the detected target, if there is no position change of the target object between a plurality of acquired X-ray image or acquired optical image, control position of the corresponding X-ray aperture blade or filter to form the irradiated area.

While certain arrangements have been described, the arrangements have been presented by way of example only, and are not intended to limit the scope of protection. The inventive concepts described herein may be implemented in a variety of other forms. In addition, various omissions, substitutions and changes to the specific implementations described herein may be made without departing from the scope of protection defined in the following claims.

1. A data processing system comprising processing circuitry configured to:
obtain a series of captured images of an object, the series of captured images comprising:
a series of fluoroscopy images of the object captured using an X-ray imaging apparatus; or
a series of optical images of the object captured during a same time period as the series of fluoroscopy frames;
provide each of at least some of the captured images to at least one image recognition model configured to determine whether a subject of a user is present in a path of an X-ray beam of the X-ray imaging apparatus;
in response to detecting the subject in the path of the X-ray beam, reduce radiation provided to the subject by controlling the X-ray imaging apparatus to adjust imaging conditions including one or more:
collimation of the X-ray beam provided by the X-ray imaging apparatus, the collimation limiting an area irradiated by the X-ray beam;
presence of a filter between an X-ray source of the X-ray imaging apparatus and the object; and
imaging parameters of the X-ray imaging apparatus; and
subsequently, in response to a predefined condition being met, controlling the X-ray imaging apparatus to further adjust the imaging conditions to increase the radiation supplied by the X-ray source to a detector of the X-ray imaging apparatus.

2. A data processing system as claimed in claim 1, wherein the imaging conditions include the imaging parameters, wherein the adjusting the imaging conditions includes one or more of:
reducing a tube current of the X-ray source; and
reducing a frame rate for subsequent fluoroscopy images captured by the X-ray imaging apparatus.

3. A data processing system as claimed in claim 1, wherein the at least one image recognition model comprises a machine learning model trained to identify the subject within the captured images.

4. A data processing system as claimed in claim 3, wherein the machine learning model is a convolutional neural network.

5. A data processing system as claimed in claim 1, wherein the at least one image recognition model is configured to output an indication of a location of the detected subject within one of the at least some of the captured images,
wherein the imaging conditions include the collimation of the X-ray beam,
wherein the controlling the imaging apparatus to adjust imaging conditions comprises, based on the indication of the location of the detected subject, adjusting the collimation to prevent at least part of the location of the detected subject from being irradiated by the X-ray beam.

6. A data processing system as claimed in claim 1, wherein the processing circuitry is configured to determine a region of the object;
wherein adjusting the collimation is performed based on a condition that the determined region of the object continues to be irradiated by the X-ray beam.

7. A data processing system as claimed in claim 6, wherein the determining the region of the object may be performed by:
providing at least one of the series of X-ray images to a further image recognition model configured to identify the region of the object.

8. A data processing system as claimed in claim 7, wherein the further image recognition model is configured to identify the region of the object by identifying an instrument within the at least one of the series of X-ray images.

9. A data processing system as claimed in claim 1, wherein the adjusted imaging conditions comprise one or more of:
the collimation of the X-ray beam; and
the imaging parameters of the X-ray imaging apparatus,
wherein the processing circuitry is configured to, following the adjustment of the imaging conditions:
obtain further fluoroscopy images of the object captured using the X-ray imaging apparatus; and
post-process each of at least some of the further fluoroscopy images by at least one of:
applying a denoising filter to the respective further fluoroscopy image; or
applying a noise reduction machine learning model to the respective further fluoroscopy image.

10. A data processing system as claimed in claim 9, wherein the processing circuitry is configured to, with respect to a first image of the further fluoroscopy images:
identify an area within the first image representing a region of interest of the object;
determine an image quality parameter associated with the area of the first image; and
in response to the image quality parameter being below a threshold, perform the post-processing with respect to subsequent ones of the further fluoroscopy images.

11. A data processing system as claimed in claim 10, wherein the processing circuitry is configured to determine a region of the object,
wherein adjusting the collimation is performed based on a condition that the determined region of the object continues to be irradiated by the X-ray beam,
wherein the region of interest is the determined region of the object.

12. A data processing system as claimed in claim 1, wherein the subject of the user is a hand of the user that is detected in the one of the captured images,
wherein the hand detected in the one of the captured images is an ungloved hand,
wherein the at least one image recognition model is further configured to determine whether a gloved hand is present in each of the at least some of the captured images,
wherein the processing circuitry is configured to, in response to detection by the at least one image recognition model of a gloved hand in a second of the captured images, perform an action to control the imaging conditions, the action being different to the adjustment to the imaging conditions performed in response to the detection of the ungloved hand.

13. A data processing system as claimed in claim 12, wherein the action to control the imaging conditions comprises preventing an automatic exposure control system from increasing an intensity of the X-rays produced by the X-ray imaging apparatus.

14. A data processing system as claimed in claim 12, wherein the at least one image recognition model comprises a first image recognition model configured to determine whether an ungloved hand is present in each of the at least some of the captured images, wherein the least one image recognition model comprises a second image recognition model configured to determine whether a gloved hand is present in each of the at least some of the captured images.

15. A data processing system as claimed in claim 1, wherein the predefined condition comprises at least one of:
a failure to detect the subject of the user in the path of X-ray beam based on ones of the captured images that were captured following the detection of the subject in the path of the X-ray beam;
a change in capture angle of the X-ray imaging apparatus;
reception of user input; and/or
expiry of a predefined time limit following adjustment of the imaging conditions.

16. A method comprising:
obtaining a series of captured images of a object, the series of captured images comprising:
a series of fluoroscopy images of the object captured using an X-ray imaging apparatus; or
a series of optical images of the object captured during a same time period as the series of fluoroscopy frames;
providing each of at least some of the captured images to at least one image recognition model configured to determine whether a subject of a user is present in a path of an X-ray beam of the X-ray imaging apparatus;
in response to detecting the subject in the path of the X-ray beam, reducing radiation provided to the subject by controlling the X-ray imaging apparatus to adjust imaging conditions including one or more:
collimation of the X-ray beam provided by the X-ray imaging apparatus, the collimation limiting an area irradiated by the X-ray beam;
presence of a filter between an X-ray source of the X-ray imaging apparatus and the object; and
imaging parameters of the X-ray imaging apparatus; and
subsequently, in response to a predefined condition being met, controlling the imaging apparatus to further adjust the imaging conditions to increase the radiation supplied by the X-ray source to a detector of the X-ray imaging apparatus.

17. A non-transitory computer readable medium storing a computer program comprising one or more sets of computer readable instructions, which when executed by at least one processor, cause a method to be performed, the method comprising:
obtaining a series of captured images of an object, the series of captured images comprising:
a series of fluoroscopy images of the object captured using an X-ray imaging apparatus; or
a series of optical images of the object captured during a same time period as the series of fluoroscopy frames;
providing each of at least some of the captured images to at least one image recognition model configured to determine whether a subject of a user is present in a path of an X-ray beam of the X-ray imaging apparatus;
in response to detecting the subject in the path of the X-ray beam, reducing radiation provided to the subject by controlling the X-ray imaging apparatus to adjust imaging conditions including one or more:
collimation of the X-ray beam provided by the X-ray imaging apparatus, the collimation limiting an area irradiated by the X-ray beam;
presence of a filter between an X-ray source of the X-ray imaging apparatus and the object; and
imaging parameters of the X-ray imaging apparatus; and
subsequently, in response to a predefined condition being met, controlling the imaging apparatus to further adjust the imaging conditions to increase the radiation supplied by the X-ray source to a detector of the X-ray imaging apparatus.
